(19) United States
(12) Patent Application Publication
(10) Pub. No.: US 2024/0057025 A1
(43) Pub. Date: Feb. 15, 2024

(54) METHODS, APPARATUSES, AND COMPUTER READABLE MEDIA FOR AUTONOMOUS GROUPING

(71) Applicant: NOKIA SOLUTIONS AND NETWORKS OY, Espoo (FI)

(72) Inventors: Wenyi XU, Shanghai (CN); Xiaobing LENG, Shanghai (CN); Li LI, Shanghai (CN); Chenhui YE, Shanghai (CN); Fei GAO, Shanghai (CN)

(21) Appl. No.: 18/258,112

(22) PCT Filed: Dec. 21, 2020
(86) PCT No.: PCT/CN2020/137980

§ 371 Date: Jun. 16, 2023

(51) Int. Cl. H04W 64/00; G01S 5/00; H04W 60/06; H04W 8/18

(52) U.S. Cl. CPC H04W 64/006; G01S 5/0072; H04W 60/06; H04W 8/186; H04W 84/18

(57) ABSTRACT

Disclosed are methods for autonomous grouping. An example method, which may be performed at a first mobile station, may include: monitoring a change of a moving pose of the first mobile station; transmitting, to at least one mobile station comprising a second mobile station, information associated with the moving pose of the first mobile station in a case of a detection of the change; and configuring a group of the first mobile station based on a response of the second mobile station to the information. Related apparatuses and computer readable media are also disclosed.

### TECHNICAL FIELD

Various embodiments relate to methods, apparatuses, and computer readable media for autonomous grouping.

### BACKGROUND

Accurate and efficient indoor and/or outdoor management services may be provided for a moving apparatus or object, such as a drone, a driverless car, and a hyper tag attached to goods transported through a cargo. Such moving apparatus may be equipped with one or more sensors for sensing or measuring information such as location and temperature, and may be configured to function as a mobile station or user equipment (UE) in one or more communication systems/networks such as a telecommunication system (for example, a new radio system and a long term evolution system) and a wireless local area network, so that the moving apparatus may report the sensed information to an entity for location management (for example, an entity for location management function or a server for location service) in the network.

### SUMMARY

In a first aspect, disclosed is an apparatus including at least one processor and at least one memory, where the at least one memory may include computer program code, and the at least one memory and the computer program code may be configured to, with the at least one processor, cause the apparatus as at least a part of a first mobile station to perform: monitoring a change of a moving pose of the first mobile station; transmitting, to at least one mobile station comprising a second mobile station, information associated with the moving pose of the first mobile station in a case of a detection of the change; and configuring a group of the first mobile station based on a response of the second mobile station to the information.

In some embodiments, the information associated with the moving pose of the first mobile station may be transmitted to the at least one mobile station via a broadcast channel.

In some embodiments, the information associated with the moving pose of the first mobile station may be transmitted with a random time delay after the detection of the change.

In some embodiments, the response of the second mobile station may include information associated with an identifier of the second mobile station, and the configuring the group of the first mobile station may include: generating an identifier of the group; transmitting the identifier of the group to the second mobile station; and adding the second mobile station into the group.

In some embodiments, the response of the second mobile station may include information associated with a group of the second mobile station, and the configuring the group of the first mobile station may include: configuring the group of the second mobile station as the group of the first mobile station.

In some embodiments, the configuring the group of the first mobile station may further include: transmitting the information associated with the group of the second mobile station to a third mobile station of the at least one mobile station in a case of a reception of a response of the third mobile station to the information associated with the moving pose of the first mobile station, the response of the third mobile station comprising information associated with the third mobile station.

In some embodiments, the information associated with the moving pose of the first mobile station may be transmitted to the second mobile station as a delegate of the group.

In some embodiments, the response of the second mobile station may include information associated with an allowance or a rejection of quitting the group, and the configuring the group of the first mobile station may include: invalidating an association between the first mobile station and the group in response to the allowance of quitting the group.

In some embodiment, the at least one memory and the computer program code may be configured to, with the at least one processor, further cause the apparatus to perform: transmitting, to at least one member mobile station in the group of the first mobile station, a request to select a delegate of the group of the first mobile station; receiving, from the at least one member mobile station, information associated with at least one status of the at least one member mobile station; selecting the delegate of the group of the first mobile station based on at least one status of the at least one fourth mobile station and a status of the first mobile station; and transmitting information associated with the selection to the at least one fourth mobile station.

In some embodiment, the at least one memory and the computer program code may be configured to, with the at least one processor, further cause the apparatus to perform: receiving, from the selected delegate of the group of the first mobile station, information associated with the group of the first mobile station and the selected delegate of the group of the first mobile station.

In some embodiment, the at least one memory and the computer program code may be configured to, with the at least one processor, further cause the apparatus to perform: receiving information associated with a status of a fourth mobile station in the group of the first mobile station from the fourth mobile station; determining to participate a delegate selection for the group of the first mobile station based on the status of the fourth mobile station and a status of the first mobile station; transmitting information associated with the determination to the fourth mobile station; and receiving information associated with a participation result of the delegate selection from the fourth mobile station.

In some embodiment, the at least one memory and the computer program code may be configured to, with the at least one processor, further cause the apparatus to perform: transmitting, to at least one member mobile station in the group of the first mobile station, information associated with the group of the first mobile station and the selected delegate of the group of the first mobile station.

In a second aspect, disclosed is a method which may be performed at a first mobile station. The method may include: monitoring a change of a moving pose of the first mobile station; transmitting, to at least one mobile station comprising a second mobile station, information associated with the moving pose of the first mobile station in a case of a detection of the change; and configuring a group of the first mobile station based on a response of the second mobile station to the information.

In some embodiments, the information associated with the moving pose of the first mobile station may be transmitted to the at least one mobile station via a broadcast channel.

In some embodiments, the information associated with the moving pose of the first mobile station may be transmitted with a random time delay after the detection of the change.

In some embodiments, the response of the second mobile station may include information associated with an identifier of the second mobile station, and the configuring the group of the first mobile station may include: generating an identifier of the group; transmitting the identifier of the group to the second mobile station; and adding the second mobile station into the group.

In some embodiments, the response of the second mobile station may include information associated with a group of the second mobile station, and the configuring the group of the first mobile station may include: configuring the group of the second mobile station as the group of the first mobile station.

In some embodiments, the configuring the group of the first mobile station may further include: transmitting the information associated with the group of the second mobile station to a third mobile station of the at least one mobile station in a case of a reception of a response of the third mobile station to the information associated with the moving pose of the first mobile station, the response of the third mobile station comprising information associated with the third mobile station.

In some embodiments, the information associated with the moving pose of the first mobile station may be transmitted to the second mobile station as a delegate of the group.

In some embodiments, the response of the second mobile station may include information associated with an allowance or a rejection of quitting the group, and the configuring the group of the first mobile station may include: invalidating an association between the first mobile station and the group in response to the allowance of quitting the group.

In some embodiment, the method may further include: transmitting, to at least one member mobile station in the group of the first mobile station, a request to select a delegate of the group of the first mobile station; receiving, from the at least one member mobile station, information associated with at least one status of the at least one member mobile station; selecting the delegate of the group of the first mobile station based on at least one status of the at least one fourth mobile station and a status of the first mobile station; and transmitting information associated with the selection to the at least one fourth mobile station.

In some embodiment, the method may further include: receiving, from the selected delegate of the group of the first mobile station, information associated with the group of the first mobile station and the selected delegate of the group of the first mobile station.

In some embodiment, the method may further include: receiving information associated with a status of a fourth mobile station in the group of the first mobile station from the fourth mobile station; determining to participate a delegate selection for the group of the first mobile station based on the status of the fourth mobile station and a status of the first mobile station; transmitting information associated with the determination to the fourth mobile station; and receiving information associated with a participation result of the delegate selection from the fourth mobile station.

In some embodiment, the method may further include: transmitting, to at least one member mobile station in the group of the first mobile station, information associated with the group of the first mobile station and the selected delegate of the group of the first mobile station.

In a third aspect, disclosed is an apparatus as at least a part of a first mobile station. The apparatus may include: means for monitoring a change of a moving pose of the first mobile station; means for transmitting, to at least one mobile station comprising a second mobile station, information associated with the moving pose of the first mobile station in a case of a detection of the change; and means for configuring a group of the first mobile station based on a response of the second mobile station to the information.

In some embodiments, the information associated with the moving pose of the first mobile station may be transmitted to the at least one mobile station via a broadcast channel.

In some embodiments, the information associated with the moving pose of the first mobile station may be transmitted with a random time delay after the detection of the change.

In some embodiments, the response of the second mobile station may include information associated with an identifier of the second mobile station, and the configuring the group of the first mobile station may include: generating an identifier of the group; transmitting the identifier of the group to the second mobile station; and adding the second mobile station into the group.

In some embodiments, the response of the second mobile station may include information associated with a group of the second mobile station, and the configuring the group of the first mobile station may include: configuring the group of the second mobile station as the group of the first mobile station.

In some embodiments, the configuring the group of the first mobile station may further include: transmitting the information associated with the group of the second mobile station to a third mobile station of the at least one mobile station in a case of a reception of a response of the third mobile station to the information associated with the moving pose of the first mobile station, the response of the third mobile station comprising information associated with the third mobile station.

In some embodiments, the information associated with the moving pose of the first mobile station may be transmitted to the second mobile station as a delegate of the group.

In some embodiments, the response of the second mobile station may include information associated with an allowance or a rejection of quitting the group, and the configuring the group of the first mobile station may include: invalidating an association between the first mobile station and the group in response to the allowance of quitting the group.

In some embodiment, the apparatus may further include: means for transmitting, to at least one member mobile station in the group of the first mobile station, a request to select a delegate of the group of the first mobile station; means for receiving, from the at least one member mobile station, information associated with at least one status of the at least one member mobile station; means for selecting the delegate of the group of the first mobile station based on at least one status of the at least one fourth mobile station and a status of the first mobile station; and means for transmitting information associated with the selection to the at least one fourth mobile station.

In some embodiment, the apparatus may further include: means for receiving, from the selected delegate of the group of the first mobile station, information associated with the group of the first mobile station and the selected delegate of the group of the first mobile station.

In some embodiment, the apparatus may further include: means for receiving information associated with a status of a fourth mobile station in the group of the first mobile station from the fourth mobile station; means for determining to participate a delegate selection for the group of the first mobile station based on the status of the fourth mobile station and a status of the first mobile station; means for transmitting information associated with the determination to the fourth mobile station; and means for receiving information associated with a participation result of the delegate selection from the fourth mobile station.

In some embodiment, the apparatus may further include: means for transmitting, to at least one member mobile station in the group of the first mobile station, information associated with the group of the first mobile station and the selected delegate of the group of the first mobile station.

In a fourth aspect, disclosed is a computer readable medium comprising instructions stored thereon for causing an apparatus as at least a part of a first mobile station to perform: monitoring a change of a moving pose of the first mobile station; transmitting, to at least one mobile station comprising a second mobile station, information associated with the moving pose of the first mobile station in a case of a detection of the change; and configuring a group of the first mobile station based on a response of the second mobile station to the information.

In some embodiments, the information associated with the moving pose of the first mobile station may be transmitted to the at least one mobile station via a broadcast channel.

In some embodiments, the information associated with the moving pose of the first mobile station may be transmitted with a random time delay after the detection of the change.

In some embodiments, the response of the second mobile station may include information associated with an identifier of the second mobile station, and the configuring the group of the first mobile station may include: generating an identifier of the group; transmitting the identifier of the group to the second mobile station; and adding the second mobile station into the group.

In some embodiments, the response of the second mobile station may include information associated with a group of the second mobile station, and the configuring the group of the first mobile station may include: configuring the group of the second mobile station as the group of the first mobile station.

In some embodiments, the configuring the group of the first mobile station may further include: transmitting the information associated with the group of the second mobile station to a third mobile station of the at least one mobile station in a case of a reception of a response of the third mobile station to the information associated with the moving pose of the first mobile station, the response of the third mobile station comprising information associated with the third mobile station.

In some embodiments, the information associated with the moving pose of the first mobile station may be transmitted to the second mobile station as a delegate of the group.

In some embodiments, the response of the second mobile station may include information associated with an allowance or a rejection of quitting the group, and the configuring the group of the first mobile station may include: invalidating an association between the first mobile station and the group in response to the allowance of quitting the group.

In some embodiment, the instructions may further cause the apparatus to perform: transmitting, to at least one member mobile station in the group of the first mobile station, a request to select a delegate of the group of the first mobile station; receiving, from the at least one member mobile station, information associated with at least one status of the at least one member mobile station; selecting the delegate of the group of the first mobile station based on at least one status of the at least one fourth mobile station and a status of the first mobile station; and transmitting information associated with the selection to the at least one fourth mobile station.

In some embodiment, the instructions may further cause the apparatus to perform: receiving, from the selected delegate of the group of the first mobile station, information associated with the group of the first mobile station and the selected delegate of the group of the first mobile station.

In some embodiment, the instructions may further cause the apparatus to perform: receiving information associated with a status of a fourth mobile station in the group of the first mobile station from the fourth mobile station; determining to participate a delegate selection for the group of the first mobile station based on the status of the fourth mobile station and a status of the first mobile station; transmitting information associated with the determination to the fourth mobile station; and receiving information associated with a participation result of the delegate selection from the fourth mobile station.

In some embodiment, the instructions may further cause the apparatus to perform: transmitting, to at least one member mobile station in the group of the first mobile station, information associated with the group of the first mobile station and the selected delegate of the group of the first mobile station.

In a fifth aspect, disclosed is an apparatus including at least one processor and at least one memory, where the at least one memory may include computer program code, and the at least one memory and the computer program code may be configured to, with the at least one processor, cause the apparatus as at least a part of a first mobile station to perform: receiving, from a second mobile station, information associated with a moving pose of the second mobile station; detecting a difference between a moving pose of the first mobile station and the moving pose of the second mobile station; and transmitting a response to the information to the second mobile station based on the detection.

In some embodiments, the response may include information associated with at least one of an identifier of the first mobile station and a group of the first mobile station.

In some embodiments, the at least one memory and the computer program code may be configured to, with the at least one processor, further cause the apparatus to perform: receiving information associated with a group of the second mobile station from the second mobile station.

In some embodiments, the at least one memory and the computer program code may be configured to, with the at least one processor, further cause the apparatus to perform: updating a configuration of the group of the first mobile station based on information associated with the group of the second mobile station.

In some embodiments, the response may include information associated with an allowance or a rejection of quitting a group of the first mobile station.

In some embodiments, the at least one memory and the computer program code may be configured to, with the at least one processor, further cause the apparatus to perform: transmitting, to at least one member mobile station in a group of the first mobile station, a request to select a delegate of the group of the first mobile station; receiving, from the at least one member mobile station, information associated with at least one status of the at least one member mobile station; selecting the delegate of the group of the first mobile station based on at least one status of the at least one fourth mobile station and a status of the first mobile station; and transmitting information associated with the selection to the at least one fourth mobile station.

In some embodiments, the at least one memory and the computer program code may be configured to, with the at least one processor, further cause the apparatus to perform: receiving, from the selected delegate of the group of the first mobile station, information associated with the group of the first mobile station and the selected delegate of the group of the first mobile station.

In some embodiments, the at least one memory and the computer program code may be configured to, with the at least one processor, further cause the apparatus to perform: receiving information associated with a status of a third mobile station in the group of the first mobile station from the fourth mobile station; determining to participate a delegate selection for the group of the first mobile station based on the status of the third mobile station and a status of the first mobile station; transmitting information associated with the determination to the third mobile station; and receiving information associated with a participation result of the delegate selection from the third mobile station.

In some embodiments, the at least one memory and the computer program code may be configured to, with the at least one processor, further cause the apparatus to perform: transmitting, to at least one member mobile station in the group of the first mobile station, information associated with the group of the first mobile station and the selected delegate of the group of the first mobile station.

In a sixth aspect, disclosed is a method which may be performed at a first mobile station. The method may include: receiving, from a second mobile station, information associated with a moving pose of the second mobile station; detecting a difference between a moving pose of the first mobile station and the moving pose of the second mobile station; and transmitting a response to the information to the second mobile station based on the detection.

In some embodiments, the response may include information associated with at least one of an identifier of the first mobile station and a group of the first mobile station.

In some embodiments, the method may further include: receiving information associated with a group of the second mobile station from the second mobile station.

In some embodiments, the method may further include: updating a configuration of the group of the first mobile station based on information associated with the group of the second mobile station.

In some embodiments, the response may include information associated with an allowance or a rejection of quitting a group of the first mobile station.

In some embodiments, the method may further include: transmitting, to at least one member mobile station in a group of the first mobile station, a request to select a delegate of the group of the first mobile station; receiving, from the at least one member mobile station, information associated with at least one status of the at least one member mobile station; selecting the delegate of the group of the first mobile station based on at least one status of the at least one fourth mobile station and a status of the first mobile station; and transmitting information associated with the selection to the at least one fourth mobile station.

In some embodiments, the method may further include: receiving, from the selected delegate of the group of the first mobile station, information associated with the group of the first mobile station and the selected delegate of the group of the first mobile station.

In some embodiments, the method may further include: receiving information associated with a status of a third mobile station in the group of the first mobile station from the fourth mobile station; determining to participate a delegate selection for the group of the first mobile station based on the status of the third mobile station and a status of the first mobile station; transmitting information associated with the determination to the third mobile station; and receiving information associated with a participation result of the delegate selection from the third mobile station.

In some embodiments, the method may further include: transmitting, to at least one member mobile station in the group of the first mobile station, information associated with the group of the first mobile station and the selected delegate of the group of the first mobile station.

In a seventh aspect, disclosed is an apparatus as at least a part of a first mobile station. The apparatus may include: means for receiving, from a second mobile station, information associated with a moving pose of the second mobile station; means for detecting a difference between a moving pose of the first mobile station and the moving pose of the second mobile station; and means for transmitting a response to the information to the second mobile station based on the detection.

In some embodiments, the response may include information associated with at least one of an identifier of the first mobile station and a group of the first mobile station.

In some embodiments, the apparatus may further include: means for receiving information associated with a group of the second mobile station from the second mobile station.

In some embodiments, the apparatus may further include: means for updating a configuration of the group of the first mobile station based on information associated with the group of the second mobile station.

In some embodiments, the response may include information associated with an allowance or a rejection of quitting a group of the first mobile station.

In some embodiments, the apparatus may further include: means for transmitting, to at least one member mobile station in a group of the first mobile station, a request to select a delegate of the group of the first mobile station; means for receiving, from the at least one member mobile station, information associated with at least one status of the at least one member mobile station; means for selecting the delegate of the group of the first mobile station based on at least one status of the at least one fourth mobile station and a status of the first mobile station; and means for transmitting information associated with the selection to the at least one fourth mobile station.

In some embodiments, the apparatus may further include: means for receiving, from the selected delegate of the group of the first mobile station, information associated with the group of the first mobile station and the selected delegate of the group of the first mobile station.

In some embodiments, the apparatus may further include: means for receiving information associated with a status of a third mobile station in the group of the first mobile station from the fourth mobile station; means for determining to participate a delegate selection for the group of the first mobile station based on the status of the third mobile station and a status of the first mobile station; means for transmitting information associated with the determination to the third mobile station; and means for receiving information associated with a participation result of the delegate selection from the third mobile station.

In some embodiments, the apparatus may further include: means for transmitting, to at least one member mobile station in the group of the first mobile station, information associated with the group of the first mobile station and the selected delegate of the group of the first mobile station.

In an eighth aspect, disclosed is a computer readable medium comprising instructions stored thereon for causing an apparatus as at least a part of a first mobile station to perform: receiving, from a second mobile station, information associated with a moving pose of the second mobile station; detecting a difference between a moving pose of the first mobile station and the moving pose of the second mobile station; and transmitting a response to the information to the second mobile station based on the detection.

In some embodiments, the response may include information associated with at least one of an identifier of the first mobile station and a group of the first mobile station.

In some embodiments, the instructions may further cause the apparatus to perform: receiving information associated with a group of the second mobile station from the second mobile station.

In some embodiments, the instructions may further cause the apparatus to perform: updating a configuration of the group of the first mobile station based on information associated with the group of the second mobile station.

In some embodiments, the response may include information associated with an allowance or a rejection of quitting a group of the first mobile station.

In some embodiments, the instructions may further cause the apparatus to perform: transmitting, to at least one member mobile station in a group of the first mobile station, a request to select a delegate of the group of the first mobile station; receiving, from the at least one member mobile station, information associated with at least one status of the at least one member mobile station; selecting the delegate of the group of the first mobile station based on at least one status of the at least one fourth mobile station and a status of the first mobile station; and transmitting information associated with the selection to the at least one fourth mobile station.

In some embodiments, the instructions may further cause the apparatus to perform: receiving, from the selected delegate of the group of the first mobile station, information associated with the group of the first mobile station and the selected delegate of the group of the first mobile station.

In some embodiments, the instructions may further cause the apparatus to perform: receiving information associated with a status of a third mobile station in the group of the first mobile station from the fourth mobile station; determining to participate a delegate selection for the group of the first mobile station based on the status of the third mobile station and a status of the first mobile station; transmitting information associated with the determination to the third mobile station; and receiving information associated with a participation result of the delegate selection from the third mobile station.

In some embodiments, the instructions may further cause the apparatus to perform: transmitting, to at least one member mobile station in the group of the first mobile station, information associated with the group of the first mobile station and the selected delegate of the group of the first mobile station.

### BRIEF DESCRIPTION OF THE DRAWINGS

Some embodiments will now be described, by way of non-limiting examples, with reference to the accompanying drawings.

FIG. 1 illustrates an example of autonomous grouping in an embodiment.

FIG. 2 illustrates an example of classifier for the autonomous grouping in an embodiment.

FIG. 3 illustrates an example of operations and communications for autonomous grouping in an embodiment.

FIG. 4 illustrates an example of operations and communications for autonomous grouping in an embodiment.

FIG. 5 illustrates an example of operations and communications for autonomous grouping in an embodiment.

FIG. 6 illustrates an example of operations and communications for autonomous grouping in an embodiment.

FIG. 7 illustrates an example method for autonomous grouping in an embodiment.

FIG. 8 illustrates an example apparatus for autonomous grouping in an embodiment.

FIG. 9 illustrates another example apparatus for autonomous grouping in an embodiment.

FIG. 10 illustrates another example method for autonomous grouping in an embodiment.

FIG. 11 illustrates another example apparatus for autonomous grouping in an embodiment.

FIG. 12 illustrates another example apparatus for autonomous grouping in an embodiment.

### DETAILED DESCRIPTION

For a plurality of moving apparatuses within a predetermined scope, such as drones in array and hyper tags attached to goods transported through cargos, a number of which may be dozens, hundreds, thousands, or even millions, they may share substantially the same or similar sensed information (for example, locations, environment temperatures, and so on), and thus may be grouped together. Further, a moving apparatus may be selected as a delegate from the group to sense and/or report the shared information of the group, while the other moving apparatuses in the group may stop or suspend the sensing and/or reporting, so that power consuming may be reduced in a whole.

One or more moving apparatuses in a group may change their locations through time. For example, drones originally in an array may change their respective routes, and may be rearranged into two or more new arrays, each of which is associated with a separate new route. For example, goods with hype tags attached may be shipped in or out. Thus, a static grouping manner for the moving apparatuses may be inefficient to adapt to such changes. For example, valuable information may be missed in a case of the static grouping due to location changes of one or more moving apparatuses in a group, and extra management effort may be brought due to manual reconfiguration.

Apparatuses moving with substantially the same or similar trace within a predetermined scope may share location information in common, where a trace may correspond to a set of moving poses accumulated through time. Thus, in one or more embodiments, a dynamic and autonomous grouping may be implemented based on moving poses for the moving apparatuses (also referred to as mobile stations or UEs herein), where respective moving apparatuses within a predetermined scope may be configured to detect their respective moving pose changes and communicate with each other, so that two or more moving apparatuses, which are within the predetermined scope and with substantially the same or similar moving poses, may be grouped together autonomously based on the communications. Further, a delegate may be selected autonomously in the group based on the communications to sense and/or report the shared information of the group, while the other moving apparatuses in the group may stop or suspending the sensing and/or reporting.

FIG. 1 illustrates an example of the autonomous grouping in an embodiment, where each of the UE 101, 102, 103, and 104 as illustrated may be configured with one or more sensors, for example, one or more inertial measurement units (IMUs), one or more accelerometers, one or more gyroscopes, and so on, through which information associated with its moving pose may be monitored or sensed, for example periodically or in real time; also, each of the UE 101, 102, 103, and 104 may be configured with one or more circuits or chips for wireless communications (for example, wireless communications based on radio frequency), based on any suitable wireless communication technologies, such as Wi-Fi™, ZigBee™ Bluetooth®, WiMax™, near field communication (NFC), sidelink, new radio (NR or 5G), long term evolution (LTE), and so on.

For example, the information associated with the moving pose of the UE (or moving pose data of the UE) may include information associated with one or more of: one or more moving directions of the UE respectively at one or more time points or timestamps; a moving pose change of the UE within a period, which for example may be represented as an accumulation of data fusion of the sensed accelerator a and angular velocity ω, for example as Σₜf(α,ω), where Σₜ(⋅) represents the accumulation within the period up to a time point or timestamp t, and f(⋅) may be any suitable pose fusion function or pose fusion method, such as Mahony method; one or more moving poses at one or more time points or timestamps, which for example may be represented by the sensed accelerators and angular velocities sensed at the one or more time points or timestamps; and so on.

Then, for two moving pose data MP(tᵢ) and MP(tⱼ) respectively corresponding to two different time points or timestamps tᵢ and tⱼ, the UE may determine whether MP(tᵢ) and MP(tⱼ) are substantially the same (or similar) or not, for example whether they are associated with substantially the same (or similar) moving direction, where any suitable classifier may be utilized for the determination, for example, but not limited to, linear regression, logistic regression, decision trees, naïve Bayes, K-Nearest neighbors, learning vector quantization, support vector machines, deep neural network or multi-layer perception, and so on.

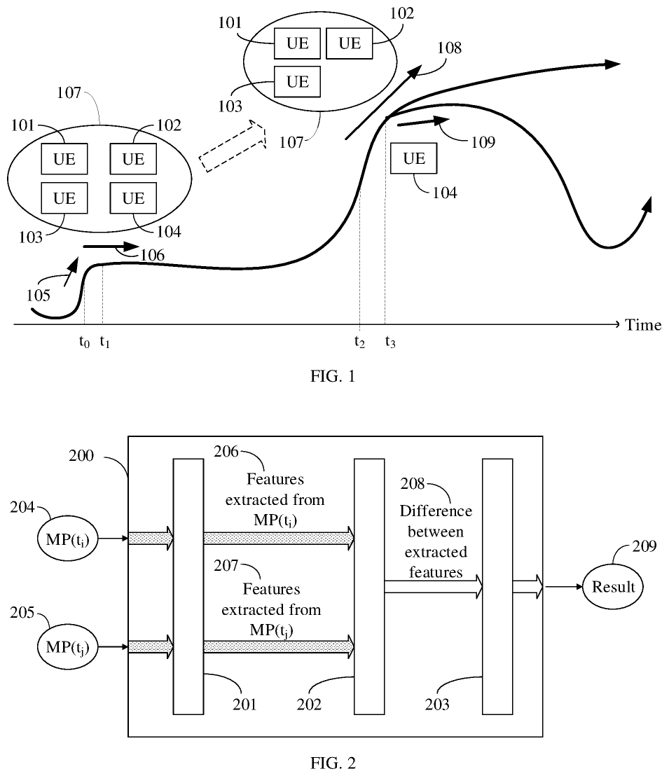

For example, as illustrated in FIG. 2, a multi-layer perception model 200 may be designed for determining whether two moving poses are associated with the same or similar moving direction, which may include one or more layers 201 for extracting features 206 and 207 respectively from input moving pose data MP(tᵢ) 204 and MP(tⱼ) 205, one or more layers 202 for determining a difference 208 between the extracted features 206 and 207, and a layer 203 for determining and outputting a determination result 209 which for example may be a probability of whether the input moving pose data MP(tᵢ) 204 and MP(tⱼ) 205 are associated with substantially the same or similar moving direction. For example, if the difference 208 between the extracted features 206 and 207 is below a predetermined threshold, the multi-layer perception model 200 may output a high probability, and otherwise a low probability. For example, the multi-layer perception model 200 may be trained based on a set of true values and any suitable loss function, for example, but not limited to, a cross-entropy loss function, a binary cross entropy loss function, a hinge loss function, an exp-loss function, a quadratic loss function, an absolution loss function, a 0-1 loss function, and so on, so that the multi-layer perception model 200 may maximize a difference between two input moving pose data which belong to different categories according to the true values, and minimize a difference two input moving pose data which belong to the same category according to the true values.

Back to FIG. 1, for example, the UE 101 determines moving pose data MP(t₀) associated with a timestamp t₀ and a moving direction 105, and moving pose data MP(t₁) associated with a timestamp t₁ and a moving direction 106. Then, the UE 101 may utilize the trained classifier model to determine whether the moving pose data MP(t₀) and MP(t₁) belong to the same category, for example whether the moving directions 105 and 106 are substantially the same of similar. For example, in a case where the output of the trained classifier indicates a low probability, the UE 101 may determine that moving poses of the UE 101 change.

Further, for example, if the UE 101 does not belong to any group or needs to establish a new group (for example, in a case where the UE 101 has been a delegate of a group), the UE 101 may transmit, one or more another UEs within a predetermined scope, a request to establish a group with the moving pose data MP(t₁). For example, the UE 101 may broadcast the request. In another example, the UE 101 may scan the UEs in the predetermined scope, and then may utilize multicast or a plurality of unicasts to transmit the request to the scanned UEs.

In response to receiving a group establishment request from the UE 101, the UE 102 may determine its own moving pose data, and may utilize the trained classifier to detect a difference between its own moving pose data and the moving pose data MP(t₁) of the UE 101, or to detect whether its own moving pose data and the moving pose data MP(t₁) of the UE 101 belong to the same category (for example, being associated with substantially the same or similar moving direction). If the UE 102 determines that its own moving pose data and the moving pose data MP(t₁) of the UE 101 belong to the same category, the UE 102 may transmit a feedback to the UE 101, which may include information associated with the UE 102 (for example, an identity or ID of the UE 102).

Then, the UE 101 may add the UE 102 in a group 107 including the UE 101, and may provide an identity or ID of the group 107 to the UE 102, so as to notify the UE 102 that the UE 102 has been added into the group 107.

Similar operations may be performed by the UE 103 and the UE 104, and similar communications may be performed between the UEs 103/104 and the UE 101. In the example as illustrated in FIG. 1, the UEs 101, 102, 103, and 104 are finally added into the group 107.

Further, for example, the UE 101 may act as the delegate of the group 107. In another example, the UE 101 may select one of the UEs 102, 103, and 104 as the delegate of the group 107, for example randomly. In yet another example, any member in the group 107 (for example, any one of the UEs 101, 102, 103, and 104) may initiate a procedure of delegate selection, which will be described herein later.

Also as illustrated in FIG. 1, the UE 104 detects a change of the moving pose at a timestamp t₃, for example a change from a moving direction 108 at a timestamp t2 to a moving direction 109 at the timestamp t₃. Then, the UE 104 may transmit a request to quit the group 107 to the delegate of the group 107. For example, the group quit request from the UE 104 may include the moving pose data MP(t₃) of the UE 104.

In response to receiving the group quit request from the UE 104, the delegate UE may determine its own moving pose data, and may utilize the trained classifier to detect a difference between its own moving pose data and the moving pose data MP(t₃) of the UE 104, or to detect whether its own moving pose data and the moving pose data MP(t₃) of the UE 104 belong to the same category (for example, being associated with substantially the same or similar moving direction). If the delegate UE determines that its own moving pose data and the moving pose data MP(t₃) of the UE 104 belong to different categories, the delegate UE may delete the UE 104 from the group 104 and transmit an acceptance message to the UE 104; otherwise, the delegate UE may transmit a rejection message to the UE 104.

In the example as illustrated in FIG. 1, the delegate UE of the group 107 determines that its own moving pose data and the moving pose data MP(t₃) of the UE 104 belong to different categories, and agrees the UE 104 to quit the group 107. Then, the delegate UE of the group 107 may continue to sense and report information for the UEs 101, 102, and 103, while the UE 104 may sense and report information by itself.

It is appreciated that FIG. 1 is merely used to illustrate an example of the autonomous grouping in an embodiment, but is not intended to limit this disclosure. For example, although 4 UEs are illustrated in FIG. 1, more or less moving UEs may be involved in another example.

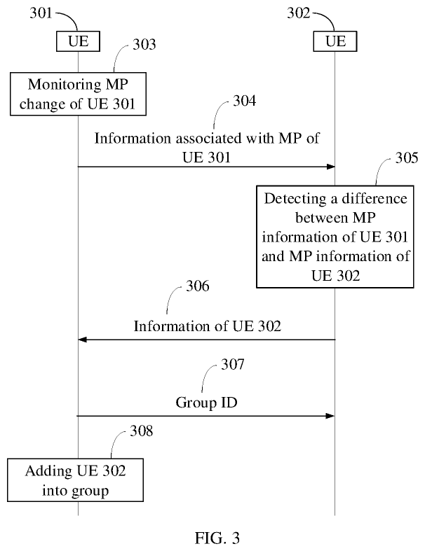

FIG. 3 illustrates an example of operations and communications for autonomous grouping in an embodiment, where UE 301 may be any one of a plurality of UEs within a predetermined scope (for example, any one of the UEs 101, 102, 103, and 104 as illustrated in FIG. 1), and UE 302 may be any another one of the plurality of UEs within the predetermined scope (for example, any another one of the UEs 101, 102, 103, and 104 as illustrated in FIG. 1).

As illustrated in FIG. 3, the UE 301 may monitor a change of a moving pose of the UE 301 in an operation 303. In the operation 303, for example, the UE 301 may utilize a trained classifier to determine whether two moving pose data of the UE 301 corresponding to two timestamps belong to the same category, for example whether they are associated with substantially the same or similar moving direction.

In a case of detecting the change of the moving pose of the UE 301 in the operation 303, the UE 301 may transmit information 304 associated with the move pose of the UE 301 to one or more another UEs in the predetermined scope, including the UE 302.

For example, if the UE 301 is a delegate of a group or the UE 301 does not belong to a group, the UE 301 may broadcast a request to establish/join a group, which request may include the information 304. In another example, the UE 301 may scan the predetermined scope for one or more “neighbor” UEs, and then may transmit the request to establish/join a group to the one or more scanned UEs, for example via a multicast message or a plurality of unicast message.

In an embodiment, the transmission of the information 304 and the operation 303 may be separated by a random time delay, so that possible conflicts, which may be brought for example by receiving another broadcasted group establishment/joining request from another UE after broadcasting the group establishment/joining request and before receiving a response to the group establishment/joining request from yet another UE, may be reduced or avoided.

As illustrated in FIG. 3, in response to receiving the information 304 broadcasted from the UE 301, the UE 302 may perform an operation 305 to detecting a difference between the moving pose of the UE 301 and the moving pose of the UE 302, for example by using the trained classifier model. In a case where the UE 302 determines in the operation 305 that the moving pose data of the UE 301 and the moving pose data of the UE 302 belong to the same category (for example, they are associated with substantially the same moving direction), the UE 302 may transmit, to the UE 301, information 306 associated with the UE 302 (for example, including an identity of the UE 302) as a response to the information 304 or the request to establish/join a group from the UE 301.

As illustrated in FIG. 3, after receiving the information 306 from the UE 302, the UE 301 may provide the UE 302 with information 307 associated with a group including the UE 301, which may include an identity of the group. For example, the UE 301 may establish a new group and determine the identity of the group based on a timestamp and a random number. In another example, if the UE 301 has already been in a group, the UE 301 may further check whether the UE 302 has already also been in the same group, and may provide the identity of the group to the UE 302 if the UE 302 has already in the same group, or otherwise establish a new group.

In an embodiment, the UE 302 may transmit, to the UE 301, an acknowledgement to the information 307 from the UE 301, which is not illustrated in FIG. 3.

Then, as illustrated in FIG. 3, the UE 301 may add the UE 302 into the group including the UE 301 in an operation 308. In addition, the UE 302 may also update its group configuration based on the received information 307.

In another embodiment, the information 306 may also include information associated with information types which are expected to be sensed. Then, the UE 301 may check whether the UE 301 may satisfy the requirements as indicated in the information 306. If the UE 301 may satisfy the requirements, the UE 301 may transmit the information 307 to the UE 302; otherwise, for example, the UE 301 may ignore the information 306, or may transmit a non-acknowledgement to the UE 302, which for example may include reasons of the non-acknowledgement.

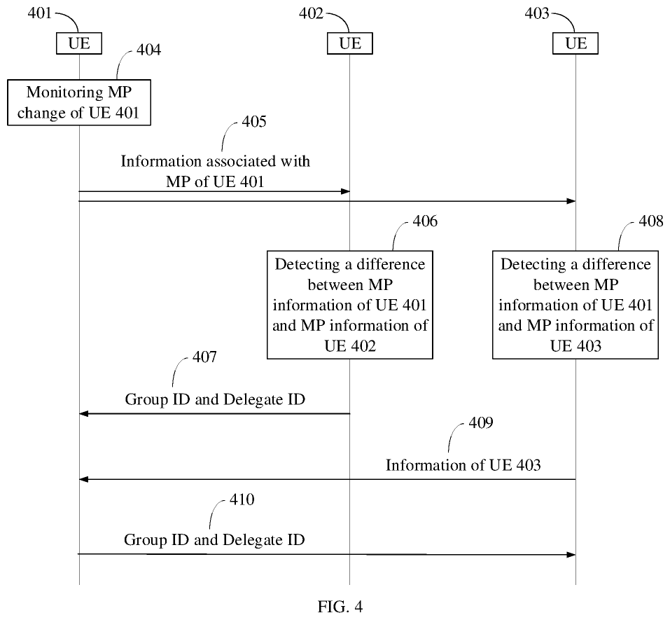

FIG. 4 illustrates another example of operations and communications for autonomous grouping in an embodiment, where UE 401 may be any one of a plurality of UEs within a predetermined scope (for example, any one of the UEs 101, 102, 103, and 104 as illustrated in FIG. 1), and UE 402 and UE 403 may be any another two of the plurality of UEs within the predetermined scope (for example, any another two of the UEs 101, 102, 103, and 104 as illustrated in FIG. 1).

As illustrated in FIG. 4, the UE 401 may monitor a change of a moving pose of the UE 401 in an operation 404. Similar to the operation 303 as illustrated in FIG. 3, in the operation 404, for example, the UE 401 may utilize a trained classifier to determine whether two moving pose data of the UE 401 corresponding to two timestamps belong to the same category, for example whether they are associated with substantially the same or similar moving direction.

In a case of detecting the change of the moving pose of the UE 401 in the operation 404, the UE 401 may transmit information 405 associated with the move pose of the UE 401 to one or more another UEs in the predetermined scope, including the UE 402 and the UE 403.

Similar to the transmission of the information 304 as illustrated in FIG. 3, for example, if the UE 401 is a delegate of a group or the UE 401 does not belong to a group, the UE 401 may broadcast a request to establish/join a group, which request may include the information 405. In another example, the UE 401 may scan the predetermined scope for one or more “neighbor” UEs, and then may transmit the request to establish/join a group to the one or more scanned UEs, for example via a multicast message or a plurality of unicast message.

In an embodiment, the transmission of the information 405 and the operation 404 may be separated by a random time delay, so that possible conflicts, which may be brought for example by receiving another broadcasted group establishment/joining request from another UE after broadcasting the group establishment/joining request and before receiving a response to the group establishment/joining request from yet another UE, may be reduced or avoided.

As illustrated in FIG. 4, after receiving the information 405 broadcasted from the UE 401, the UE 402 may perform an operation 406 to detecting a difference between the moving pose of the UE 401 and the moving pose of the UE 402, for example by using the trained classifier model. In a case where the UE 402 determines in the operation 406 that the moving pose data of the UE 401 and the moving pose data of the UE 402 belong to the same category (for example, they are associated with substantially the same moving direction) and the UE 402 has already been in a group, the UE 402 may transmit, to the UE 401, information 407 associated with the group of the UE 402 (for example, including an identity of the group of the UE 402 and an identity of a delegate of the group of the UE 402) as a response to the information 405 or the request to establish/join a group from the UE 401. For example, if the UE 402 is the delegate of the group of the UE 402, the UE 402 may add the UE 401 into the group.

After receiving information 407 from the UE 402, the UE 401 may configure its group based on the received information 407. For example, the UE 401 may also transmit a request to the delegate indicated in the information 407 to join the group in the information 407.

Then, as illustrated in FIG. 4, after receiving the information 405 broadcasted from the UE 401, the UE 403 may perform an operation 408 to detecting a difference between the moving pose of the UE 401 and the moving pose of the UE 403, for example by using the trained classifier model. In a case where the UE 403 determines in the operation 408 that the moving pose data of the UE 401 and the moving pose data of the UE 403 belong to the same category (for example, they are associated with substantially the same moving direction) and the UE 403 is not in a group, the UE 403 may transmit, to the UE 401, information 409 associated with the UE 403 (for example, including an identity of the UE 403) as a response to the information 405 or the request to establish/join a group from the UE 401.

In the example as illustrated in FIG. 4, it is assumed that the UE 401 receives the information 409 after the information 407. Then, the UE 401 may transmit, to the UE 403, information 410 associated with the group including both UE 401 and UE 402. The information 410 may include the identity of the group and the identity of the delegate of the group, which have been notified via the information 407, so that the UE 403 may configure its group based on the received information 410.

In another example where the UE 401 receives information 409 before the information 407, as a response to the information 405, the UE 401 may transmit, to the UE 403, information similar to the information 307 and possibly including an identity of a new group. Then, after receiving the information 407, if the UE 401 may determine to use the group configuration based on the information 407, the UE 401 may transmit the information 410 to the UE 403 so that the UE 403 may update the group configuration based on the information 410. In yet another example, the UE 401 may also determine to ignore the information 407 and maintain the group including the UE 401 and the UE 403.

In an embodiment, after receiving the information 407, the UE 401 may also transmit an acknowledgment or non-acknowledgement to the UE 402, so that the UE 403 may know whether its suggested group configuration has been accepted by the UE 401. For example, if the UE 402 is a delegate of a group, the UE 402 may determine whether to add the UE 401 into the group, based on the acknowledgment or non-acknowledgement from the UE 401.

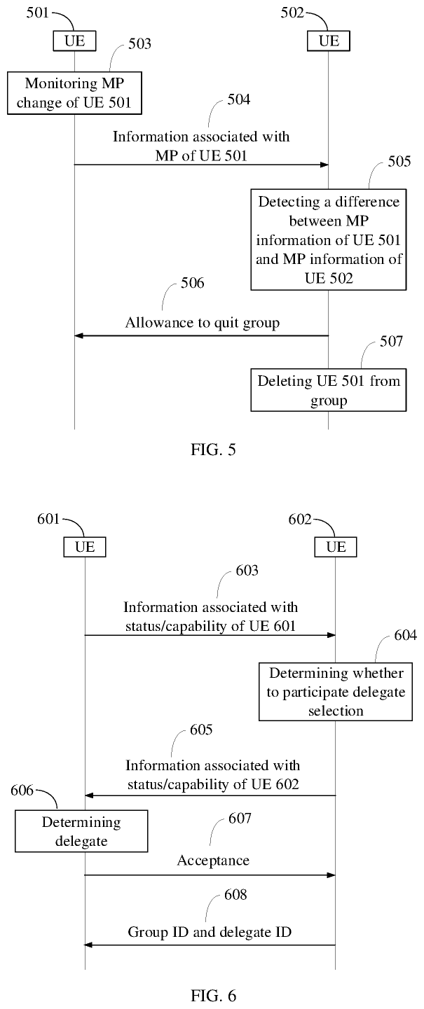

FIG. 5 illustrates another example of operations and communications for autonomous grouping in an embodiment, where UE 501 may be any one of a plurality of UEs within a predetermined scope (for example, any one of the UEs 101, 102, 103, and 104 as illustrated in FIG. 1), UE 502 may be any another one of the plurality of UEs within the predetermined scope (for example, any another one of the UEs 101, 102, 103, and 104 as illustrated in FIG. 1), and the UE 502 is the delegate of the group including the UE 501 and the UE 502.

As illustrated in FIG. 5, the UE 501 may monitor a change of a moving pose of the UE 501 in an operation 503. Similar to the operation 303 as illustrated in FIG. 3, in the operation 503, for example, the UE 501 may utilize a trained classifier to determine whether two moving pose data of the UE 501 corresponding to two timestamps belong to the same category, for example whether they are associated with substantially the same or similar moving direction.

In a case of detecting the change of the moving pose of the UE 501 in the operation 503, the UE 501 may transmit information 504 associated with the move pose of the UE 501 to the UE 502 which is the delegate of the group including the UE 501.

In response to receiving the information 504 from the UE 501, the UE 502 may perform an operation 505 to detect a difference between the moving pose of the UE 501 and the moving pose of the UE 502, for example by using the trained classifier model.

In a case where the UE 502 determines in the operation 505 that the moving pose data of the UE 501 and the moving pose data of the UE 502 belong to different categories (for example, they are associated with different moving directions), the UE 502 may transmit, to the UE 501, information 506 for allowing the UE 501 to quit the group. Also, the UE 502 may perform an operation 507 to delete the UE 501 from the group.

In a case where the UE 502 determines in the operation 505 that the moving pose data of the UE 501 and the moving pose data of the UE 502 still belong to the same category (for example, they are still associated with substantially the same or similar moving direction), the UE 502 may transmit, to the UE 501, information for rejecting the UE 501 to quit the group. Also, both the UE 501 and the UE 502 may maintain their respective group configurations unchanged.

FIG. 6 illustrates an example of operations and communications for delegate selection in an autonomous grouping in an embodiment, where UE 601 and UE 602 may be any two members in the same group.

In various embodiments, the UE 601 may initiate the delegate selection/reselection in response to one or more predetermined conditions. For example, the UE 601 may initiate the delegate selection after the UE 601 establishes a group. In another example, the UE 601 may initiate the delegate selection/reselection after the UE 601 joins a group. In yet another example, the UE 601 may initiate the delegate selection/reselection in response to obtaining more powers.

As illustrated in FIG. 6, for the delegate selection/reselection, the UE 601 may multicast information 603 associated with the status and/or capability of the UE 601 to the other member(s) in the group, including the UE 602. For example, the information 603 may include information associated with one or more of: a battery life; power; sensing capability; and so on. In another example, the information 603 may be transmitted via a plurality of unicast messages or a broadcast (for example, also with the identity of the group).

As illustrated in FIG. 6, in response to receiving the information 603 from the UE 601, the UE 602 may determine in an operation 604 whether the UE 602 participates the delegate selection, for example by comparing a status/capability of the UE 602 and the status/capability of the UE 601. For example, in the operation 604, the UE 602 may calculate a weighted score of one or more factors such as power, battery life, sensing capability, and so on. If the calculated score is above a predetermined value, the UE 602 may determine to participate the delegate selection/reselection, and may transmit information 605 associated with the status/capability of the UE 602 to the UE 601.

For example, if the UE 601 does not receive any information associated with status/capability from another member in the group within a predetermined period of time, the UE 601 determine in an operation 606 that the UE 601 becomes the delegate of the group, and may multicast information associated with the new group configuration, which may include the identity of the group and the identity of the new delegate (the identity of the UE 601), to the other member(s) in the group.

For example, as illustrated in FIG. 6, if the UE 601 receives information associated with the status/capability from at least one member in the group within the predetermined period of time, such as the information 605 associated with the status/capability of the UE 602 from the UE 602, then in the operation 606, the UE 601 may determine a delegate from the UE 601, the UE 602, and possibly other one or more group members which have transmitted the information associated with the status/capability in response to the information 603. In different embodiments, in the operation 606, the UE 601 may select the delegate randomly or according to an order of time of receiving the information associated with the status/capability, or the UE 601 may select the delegate to be the UE with longest battery life or highest power, or the UE 601 may calculate scores (for example, the above weighted scores) for respective participants and determine the one with highest score, or the like.

In the example as illustrated in FIG. 6, in the operation 606, the UE 601 determines the UE 602 as the new delegate of the group. Then, as illustrated in FIG. 6, the UE 601 may transmit, to the UE 601, information 607 for accepting the UE 602 as the new delegate of the group.

In response to receiving the information 607 from the UE 601 which is the initiator of the delegate selection/reselection, the UE 602 may update its group configuration by marking the UE 602 as the delegate of the group, and may multicast information 608 associated with the new group configuration (including the identity of the group and the identity of the new delegate of the group) to the members of the group, so that the members in the group may update their respective group configurations accordingly.

In an embodiment, the new delegate of the group, for example the UE 602, may also transmit information associated with the new group configuration (for example, including, but not limited to, one or more of: the identity of the group, a list of the UEs in the group, the identity of the delegate of the group, and so on) to a base station in an access work. Further, the base station may register or update the information associated with the group configuration, and may also inform at least the update of the group configuration to the core network, for example to the LMF in the core network.

Thus, the delegate of the group, for example the UE 602, may sense information shared by the group, such as location, environment temperature, and so on. Also, the delegate of the group may exchange information (e.g. location information) on behalf of the group with the base station and/or the core network (e.g. the LMF in the core network).

It is appreciated that this disclosure is not limited to the above examples. For example, in another example, after the UE 601 determines the delegate in the operation 606, the UE 601 may also multicast the selected delegate to the members of the group.

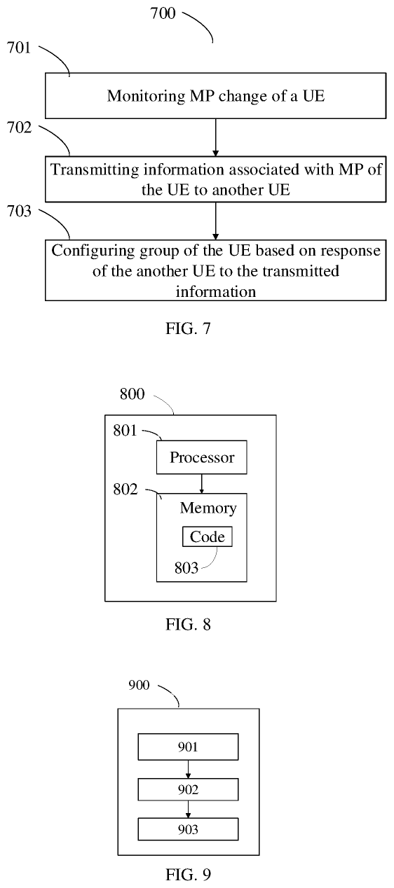

FIG. 7 illustrates an example method 700 for autonomous grouping in an embodiment, which may be performed by any UE of a plurality of UEs within a predetermined scope.

As illustrated in FIG. 7, the example method 700 for autonomous grouping may include an operation 701, an operation 702, and an operation 703.

In the operation 701, the UE may monitor a change of a moving pose of the UE. For example, in the operation 701, the UE may sense information such as location and temperature by means of one or more embedded sensors (such as IMUs, accelerometers, gyroscopes, and so on), and may determine moving pose data by using any suitable pose fusion method (for example, the Mahony method) based on the sensed accelerators, angular velocities, and so on. Then, the UE may utilize a trained classifier to determine whether two moving pose data of the UE belong to the same category (for example, whether they are associated with substantially the same or similar moving directions).

In a case where it is detected that there is a change of moving pose of the UE, in the operation 702, the UE may transmit information associated with the moving pose of the UE to at least one another UE, for example via a broadcast channel in a case where the UE does not belong to a group or the UE is a delegate of a group, or via a unicast channel in a case where the UE is in a group but it is not the delegate of the group. For example, the operation 702 and the operation 701 may be separated by a random time delay.

Then, in the operation 703, the UE may configure its group based on a response to the information transmitted in the operation 702, which is received from another UE for example within a predetermined period of time after the operation 702. In different embodiments, the response may be associated with a request from the another UE to apply to join the group of the UE, which may include information associated with the another UE (e.g. the identity of the another UE), or the response may be associated with a suggestion from the another UE with respect to the group configuration, which may include information associated with the group of the another UE (e.g. the identity of the group of the another UE and the identity of the delegate of the group), or the response may be associated with an indication to accept or reject the UE to quit a group, or the like.

Through the example method 700, the UE may configure its group autonomously and dynamically.

In some embodiments, the response from the another UE may include information associated with an identifier of the another UE, and in the operation 703, the UE may generate an identifier of the group, transmit the identifier of the group to the another UE, and add the another UE into the group.

In some embodiments, the response from the another UE may include information associated with a group of from the another UE, and in the operation 703, the UE may configure the group of the another UE as the group of the UE.

In some embodiments, in the operation 703, the UE may transmit the information associated with the group of the another UE to yet another UE for example in a case of a reception of a response of the yet another UE to the information associated with the moving pose of the UE, where the response for the yet another UE may include information associated with the yet another UE (e.g. the identity of the yet another UE).

In some embodiments, in the operation 702, the information associated with the moving pose of the UE may be transmitted to a delegate of the group.

In some embodiments, the response from the delegate may include information associated with an allowance or a rejection of quitting the group, and in the operation 703, the UE may invalidate an association between the UE and the group in response to the allowance of quitting the group.

In some embodiments, the example method 700 may further include: transmitting, to at least one member UE in the group of the UE, a request to select a delegate of the group of the UE; receiving, from the at least one member UE, information associated with at least one status of the at least one member UE; selecting the delegate of the group of the UE based on at least one status of the at least one another UE and a status of the UE; and transmitting information associated with the selection (for example, an indication to accept or reject the another UE to be the delegate) to the at least one member UE. Further, the example method 700 may also include receiving, from the selected delegate, information associated with the group and the selected delegate.

In some embodiments, the example method 700 may further include: receiving information associated with a status of another UE in the group of the UE from the another UE; determining to participate a delegate selection for the group based on the status of the another UE and a status of the UE; transmitting information associated with the determination to the another UE, where, for example, the information may include a status or capability of the UE; and receiving information associated with a participation result of the delegate selection (for example, an acceptance or a rejection) from the another UE. Further, the example method 700 may also include: transmitting, to the members in the group (for example, via a multicast channel), information associated with the group and the selected delegate (for example, the identity of the group and the identity of the selected delegate).

FIG. 8 illustrates an example apparatus 800 for autonomous grouping in an embodiment, which may be at least a part of a mobile station or UE.

As shown in FIG. 8, the example apparatus 800 may include at least one processor 801 and at least one memory 802 that may include computer program code 803. The at least one memory 802 and the computer program code 803 may be configured to, with the at least one processor 801, cause the apparatus 800 at least to perform at least the operations of the example method 700 described above.

In various embodiments, the at least one processor 801 in the example apparatus 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 801 may also include at least one other circuitry or element not shown in FIG. 8.

In various embodiments, the at least one memory 802 in the example apparatus 800 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 802 may include, but are not limited to, an electric, a magnetic, an optical, an electromagnetic, an infrared, or a semiconductor system, apparatus, or device or any combination of the above.

Further, in various embodiments, the example apparatus 800 may also include at least one other circuitry, element, and interface, for example at least one I/O interface, at least one antenna element, and the like.

In various embodiments, the circuitries, parts, elements, and interfaces in the example apparatus 800, including the at least one processor 801 and the at least one memory 802, may be coupled together via any suitable connections including, but not limited to, buses, crossbars, wiring and/or wireless lines, in any suitable ways, for example electrically, magnetically, optically, electromagnetically, and the like.

FIG. 9 illustrates another example apparatus 900 for autonomous grouping in an embodiment, which may be at least a part of a mobile station or UE.

As illustrated in FIG. 9, the example apparatus 900 may include means 901 for performing the operation 701 of the example method 700, means 902 for performing the operation 702 of the example method 700, and means 903 for performing the operation 703 of the example method 700. In one or more another embodiment, at least one I/O interface, at least one antenna element, and the like may also be included in the example apparatus 900. In some embodiments, examples of means in the apparatus 900 may include circuitries. In some embodiments, examples of means may also include software modules and any other suitable function entities. In some embodiments, one or more additional means may be included in the apparatus 900 for performing one or more additional operations of the example method 700.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

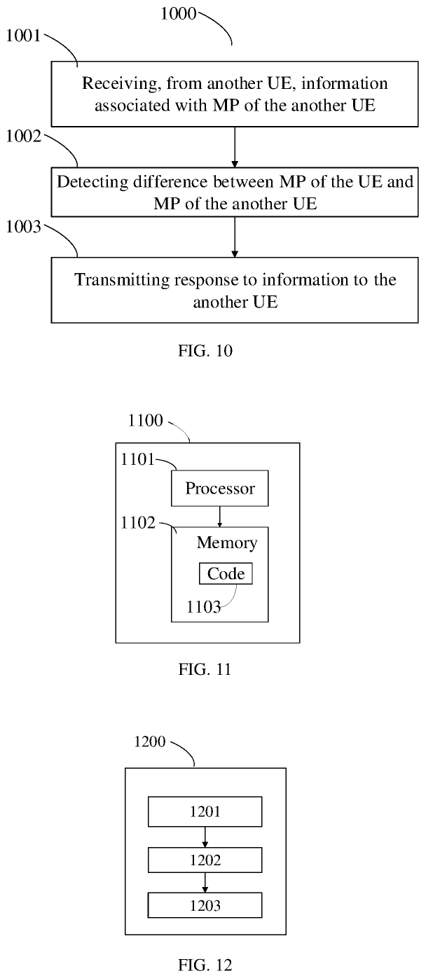

FIG. 10 illustrates another example method 1000 for autonomous grouping in an embodiment, which may be performed by any UE of a plurality of UEs within a predetermined scope. It is appreciated that any UE of the plurality of UEs with the predetermined scope may be configured to perform both the example method 700 and the example method 1000.

As illustrated in FIG. 10, the example method 1000 may include an operation 1001, an operation 1002, and an operation 1003.

In the operation 1001, the UE may receive, from another UE, information associated with a moving pose of the another UE. For example, the information may be transmitted by the another UE by perform the above operation 702 of the example method 700.

In the operation 1002, the UE may detect a difference between a moving pose of the UE and the moving pose of the another UE. For example, similar to the operation 701 of the example method 700, in the operation 1002, the UE may sense information such as location and temperature by means of one or more embedded sensors (such as IMUs, accelerometers, gyroscopes, and so on), and may determine moving pose data by using any suitable pose fusion method (for example, the Mahony method) based on the sensed accelerators, angular velocities, and so on. Then, the UE may utilize a trained classifier to determine whether the moving pose data of the UE and the moving pose data of the another UE belong to the same category (for example, whether they are associated with substantially the same or similar moving directions).

Then, in the operation 1003, the UE may transmit a response to the another UE based on the detection in the operation 1002, so that the another UE may perform the operation 703 of the example method 700.

In some embodiments, the response transmitted in the operation 1003 may include information associated with at least one of an identifier of the UE and a group of the UE (e.g. the identity of the group of the UE).

In some embodiments, the example method 1000 may further include: receiving information associated with a group of the another UE from the another UE.

In some embodiments, the example method 1000 may further include: updating a configuration of the group of the UE based on information associated with the group of the another UE.

In some embodiments, the response transmitted in the operation 1003 may include information associated with an allowance or a rejection of quitting a group of the UE.

In some embodiments, the example method 1000 may further include: transmitting, to at least one member UE in the group of the UE, a request to select a delegate of the group of the UE; receiving, from the at least one member UE, information associated with at least one status of the at least one member UE; selecting the delegate of the group of the UE based on at least one status of the at least one another UE and a status of the UE; and transmitting information associated with the selection (for example, an indication to accept or reject the another UE to be the delegate) to the at least one member UE. Further, the example method 1000 may also include receiving, from the selected delegate, information associated with the group and the selected delegate.

In some embodiments, the example method 1000 may further include: receiving information associated with a status of another UE in the group of the UE from the another UE; determining to participate a delegate selection for the group based on the status of the another UE and a status of the UE; transmitting information associated with the determination to the another UE, where, for example, the information may include a status or capability of the UE; and receiving information associated with a participation result of the delegate selection (for example, an acceptance or a rejection) from the another UE. Further, the example method 1000 may also include: transmitting, to the members in the group (for example, via a multicast channel), information associated with the group and the selected delegate (for example, the identity of the group and the identity of the selected delegate).

FIG. 11 illustrates another example apparatus 1100 for autonomous grouping in an embodiment, which may be at least a part of a mobile station or UE.

As shown in FIG. 11, the example apparatus 1100 may include at least one processor 1101 and at least one memory 1102 that may include computer program code 1103. The at least one memory 1102 and the computer program code 1103 may be configured to, with the at least one processor 1101, cause the apparatus 1100 at least to perform at least the operations of the example method 1000 described above.

In various embodiments, the at least one processor 1101 in the example apparatus 1100 may include, but not limited to, at least one hardware processor, including at least one microprocessor such as a CPU, a portion of at least one hardware processor, and any other suitable dedicated processor such as those developed based on for example FPGA and ASIC. Further, the at least one processor 1101 may also include at least one other circuitry or element not shown in FIG. 11.

In various embodiments, the at least one memory 1102 in the example apparatus 1100 may include at least one storage medium in various forms, such as a volatile memory and/or a non-volatile memory. The volatile memory may include, but not limited to, for example, a RAM, a cache, and so on. The non-volatile memory may include, but not limited to, for example, a ROM, a hard disk, a flash memory, and so on. Further, the at least memory 1102 may include, but are not limited to, an electric, a magnetic, an optical, an electromagnetic, an infrared, or a semiconductor system, apparatus, or device or any combination of the above.

Further, in various embodiments, the example apparatus 1100 may also include at least one other circuitry, element, and interface, for example at least one I/O interface, at least one antenna element, and the like.

In various embodiments, the circuitries, parts, elements, and interfaces in the example apparatus 1100, including the at least one processor 1101 and the at least one memory 1102, may be coupled together via any suitable connections including, but not limited to, buses, crossbars, wiring and/or wireless lines, in any suitable ways, for example electrically, magnetically, optically, electromagnetically, and the like.

FIG. 12 illustrates another example apparatus 1200 for autonomous grouping in an embodiment, which may be at least a part of a mobile station or UE.

As illustrated in FIG. 12, the example apparatus 1200 may include means 1201 for performing the operation 1001 of the example method 1000, means 1202 for performing the operation 1002 of the example method 1000, and means 1203 for performing the operation 1003 of the example method 1000. In one or more another embodiment, at least one I/O interface, at least one antenna element, and the like may also be included in the example apparatus 1200. In some embodiments, examples of means in the apparatus 1200 may include circuitries. In some embodiments, examples of means may also include software modules and any other suitable function entities. In some embodiments, one or more additional means may be included in the apparatus 1200 for performing one or more additional operations of the example method 1000.

In an embodiment, the means in the example apparatus 1200 may be also included in the example apparatus 800 or 900 for performing the example method 700.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

1. An apparatus comprising:
at least one processor; and
at least one memory including computer program code, the at least one memory and the computer program code being configured to, with the at least one processor, cause the apparatus as at least a part of a first mobile station to perform:
monitoring a change of a moving pose of the first mobile station;
transmitting, to at least one mobile station comprising a second mobile station, information associated with the moving pose of the first mobile station in a case of a detection of the change; and
configuring a group of the first mobile station based on a response of the second mobile station to the information.

2. The apparatus of claim 1 wherein the information associated with the moving pose of the first mobile station is transmitted to the at least one mobile station via a broadcast channel.

3. The apparatus of claim 2 wherein the information associated with the moving pose of the first mobile station is transmitted with a random time delay after the detection of the change.

4. The apparatus of claim 1 wherein the response of the second mobile station comprises information associated with an identifier of the second mobile station, and the configuring the group of the first mobile station comprises:
generating an identifier of the group;
transmitting the identifier of the group to the second mobile station; and
adding the second mobile station into the group.

5. The apparatus of claim 1 wherein the response of the second mobile station comprises information associated with a group of the second mobile station, and the configuring the group of the first mobile station comprises:
configuring the group of the second mobile station as the group of the first mobile station.

6. The apparatus of claim 5 wherein the configuring the group of the first mobile station further comprises:
transmitting the information associated with the group of the second mobile station to a third mobile station of the at least one mobile station in a case of a reception of a response of the third mobile station to the information associated with the moving pose of the first mobile station, the response of the third mobile station comprising information associated with the third mobile station.

7. The apparatus of claim 1 wherein the information associated with the moving pose of the first mobile station is transmitted to the second mobile station as a delegate of the group.

8. The apparatus of claim 1 wherein the response of the second mobile station comprises information associated with an allowance or a rejection of quitting the group, and the configuring the group of the first mobile station comprises:
invalidating an association between the first mobile station and the group in response to the allowance of quitting the group.

9. The apparatus of claim 1 wherein the at least one memory and the computer program code are configured to, with the at least one processor, further cause the apparatus to perform:
transmitting, to at least one member mobile station in the group of the first mobile station, a request to select a delegate of the group of the first mobile station;
receiving, from the at least one member mobile station, information associated with at least one status of the at least one member mobile station;
selecting the delegate of the group of the first mobile station based on at least one status of the at least one fourth mobile station and a status of the first mobile station; and
transmitting information associated with the selection to the at least one fourth mobile station.

10. The apparatus of claim 9 wherein the at least one memory and the computer program code are configured to, with the at least one processor, further cause the apparatus to perform:
receiving, from the selected delegate of the group of the first mobile station, information associated with the group of the first mobile station and the selected delegate of the group of the first mobile station.

11. The apparatus of claim 1 wherein the at least one memory and the computer program code are configured to, with the at least one processor, further cause the apparatus to perform:
receiving information associated with a status of a fourth mobile station in the group of the first mobile station from the fourth mobile station;
determining to participate a delegate selection for the group of the first mobile station based on the status of the fourth mobile station and a status of the first mobile station;
transmitting information associated with the determination to the fourth mobile station; and
receiving information associated with a participation result of the delegate selection from the fourth mobile station.

12. The apparatus of claim 11 wherein the at least one memory and the computer program code are configured to, with the at least one processor, further cause the apparatus to perform:
transmitting, to at least one member mobile station in the group of the first mobile station, information associated with the group of the first mobile station and the selected delegate of the group of the first mobile station.

13. An apparatus comprising:
at least one processor; and
at least one memory including computer program code, the at least one memory and the computer program code being configured to, with the at least one processor, cause the apparatus as at least a part of a first mobile station to perform:
receiving, from a second mobile station, information associated with a moving pose of the second mobile station;
detecting a difference between a moving pose of the first mobile station and the moving pose of the second mobile station; and
transmitting a response to the information to the second mobile station based on the detection.

14. The apparatus of claim 13 wherein the response comprises information associated with at least one of an identifier of the first mobile station and a group of the first mobile station.

15. The apparatus of claim 14 wherein the at least one memory and the computer program code are configured to, with the at least one processor, further cause the apparatus to perform:
receiving information associated with a group of the second mobile station from the second mobile station.

16. The apparatus of claim 15 wherein the at least one memory and the computer program code are configured to, with the at least one processor, further cause the apparatus to perform:
updating a configuration of the group of the first mobile station based on information associated with the group of the second mobile station.

17. The apparatus of claim 13 wherein the response comprises information associated with an allowance or a rejection of quitting a group of the first mobile station.

18. The apparatus of claim 13 wherein the at least one memory and the computer program code are configured to, with the at least one processor, further cause the apparatus to perform:
transmitting, to at least one member mobile station in a group of the first mobile station, a request to select a delegate of the group of the first mobile station;
receiving, from the at least one member mobile station, information associated with at least one status of the at least one member mobile station;
selecting the delegate of the group of the first mobile station based on at least one status of the at least one fourth mobile station and a status of the first mobile station; and
transmitting information associated with the selection to the at least one fourth mobile station.

19. The apparatus of claim 18 wherein the at least one memory and the computer program code are configured to, with the at least one processor, further cause the apparatus to perform:
receiving, from the selected delegate of the group of the first mobile station, information associated with the group of the first mobile station and the selected delegate of the group of the first mobile station.

20. The apparatus of claim 13 wherein the at least one memory and the computer program code are configured to, with the at least one processor, further cause the apparatus to perform:
receiving information associated with a status of a third mobile station in the group of the first mobile station from the fourth mobile station;
determining to participate a delegate selection for the group of the first mobile station based on the status of the third mobile station and a status of the first mobile station;
transmitting information associated with the determination to the third mobile station; and
receiving information associated with a participation result of the delegate selection from the third mobile station.

21. The apparatus of claim 20 wherein the at least one memory and the computer program code are configured to, with the at least one processor, further cause the apparatus to perform:
transmitting, to at least one member mobile station in the group of the first mobile station, information associated with the group of the first mobile station and the selected delegate of the group of the first mobile station.

22. A method comprising:
monitoring a change of a moving pose of a first mobile station;
transmitting, to at least one mobile station comprising a second mobile station, information associated with the moving pose of the first mobile station in a case of a detection of the change; and
configuring a group of the first mobile station based on a response of the second mobile station to the information.

23-33. (canceled)

34. A method comprising:
receiving, at a first mobile station and from a second mobile station, information associated with a moving pose of the second mobile station;
detecting a difference between a moving pose of the first mobile station and the moving pose of the second mobile station; and
transmitting a response to the information to the second mobile station based on the detection.

33-45. (canceled)
